(19) United States
(12) Patent Application Publication
(10) Pub. No.: US 2010/0014624 A1
(43) Pub. Date: Jan. 21, 2010

(54) Nuclear reactor components including material layers to reduce enhanced corrosion on zirconium alloys used in fuel assemblies and methods thereof

(75) Inventors: Daniel R. Lutz, San Jose, CA (US); Young Jin Kim, Clifton Park, NY (US); Yang-Pi Lin, Wilmington, NC (US)

Correspondence Address: HARNESS, DICKEY & PIERCE, P.L.C., P.O. BOX 8910, RESTON, VA, 20195, US

(73) Assignee: Global Nuclear Fuel - Americas, LLC

(21) Appl. No.: 12/219,212

(22) Filed: Jul. 17, 2008

(51) Int. Cl. G21C 9/00; G21F 1/08

(52) U.S. Cl. 376/305

(57) ABSTRACT

Example embodiments are directed to providing a thin, adherent coating on the surfaces of nuclear reactor components, which are known to cause increased corrosion on adjacent zirconium alloy structures, and methods of reducing the increased corrosion. Example embodiments include coatings being structurally bonded to components such that the difference in the corrosion potential between a coated component and a zirconium alloy component is less than that between a component without the coating and the zirconium alloy component.

### BACKGROUND

1. Field

Example embodiments generally relate to nuclear reactors including components that have reduced shadow corrosion on zirconium alloys and methods thereof.

2. Description of Related Art

Generally, nuclear power plants include a reactor core having fuel arranged therein to produce power by nuclear fission. A common design in nuclear power plants is to arrange fuel in a plurality of fuel rods bound together as a fuel assembly, or fuel bundle, placed within the reactor core. These fuel rods typically include several elements joining the fuel rods to assembly components at various axial locations throughout the assembly.

As shown in FIG. 1, a conventional fuel bundle 10 of a nuclear reactor, such as a BWR, may include an outer channel 12 surrounding an upper tie plate 14 and a lower tie plate 16. A plurality of full-length fuel rods 18 and/or partial length fuel rods 19 may be arranged in a matrix within the fuel bundle 10 and pass through a plurality of spacers 20. Fuel rods 18 and 19 generally originate and terminate at upper and lower tie plates 14 and 16, continuously running the length of the fuel bundle 10, with the exception of partial length rods 19, which all terminate at a lower vertical position from the full length rods 18. FIG. 1B illustrates a conventional BWR 75, including four fuel assemblies 10 and a control blade 15.

Corrosion is commonly observed on e.g., channel 12 made of Zircaloys when, for example, a control blade 15, constructed with a stainless steel outer casing, is placed close to the channel 12. Zircaloys are well known high zirconium alloys commonly used in nuclear reactors. Corrosion may also be found on Zircaloy fuel cladding in contact with or close to nuclear components made from nickel and/or iron based alloys, e.g., a spacer 20 or spacer spring (not shown). The corrosion, also known as “shadow” corrosion, weakens the Zircaloy components and decreases the components useful lifespan.

### SUMMARY

Example embodiments are directed to providing a thin, adherent coating on the surfaces of nuclear reactor components that are known to cause increased corrosion on adjacent zirconium alloy structures and methods of reducing the increased corrosion. Example embodiments include coatings structurally bonded to components such that the difference in the corrosion potential between a coated component and a zirconium alloy component is less than that between a component without the coating and the zirconium alloy component.

Example embodiments include nuclear reactors comprising a first component formed of at least one material selected from nickel based alloys and iron based alloys, and a second component adjacent to the first component. The second component is formed of a zirconium alloy. A material layer is formed on at least one surface of the first component. The material layer is formed of a different material than the first component such that a difference in electrochemical corrosion potential between the first component and the second component is reduced.

Example embodiments also include methods of enhancing zirconium corrosion resistance in a nuclear reactor fuel assembly by forming a material layer on at least one surface of a first component adjacent to a second component, such that a difference in electrochemical potential between the first component and the second component is reduced.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1A is an illustration of a conventional art fuel assembly.

FIG. 1B is an illustration of a conventional BWR including four fuel assemblies and a control blade.

FIG. 2A is a cross section of a surface of a nuclear reactor component having a thin material layer thereon according to example embodiments.

FIG. 2B is a cross section of a surface of a nuclear reactor component having a thin material layer and a buffer layer thereon according to example embodiments.

FIG. 3 is a graph of electrochemical corrosion potential vs. oxygen concentration for 304 SS, Zircaloy-2, and pure zirconium.

FIG. 4 is a graph of electrochemical corrosion potential vs. immersion time of a Zircaloy-2 coated 304 SS electrode.

FIG. 5 is a graph illustrating the results of an experiment showing a comparison of corrosion potential vs. immersion time of TiO2 coated Fe—Cr—Ni alloy and zirconium alloy using UV to simulate the radiation experienced during nuclear processing.

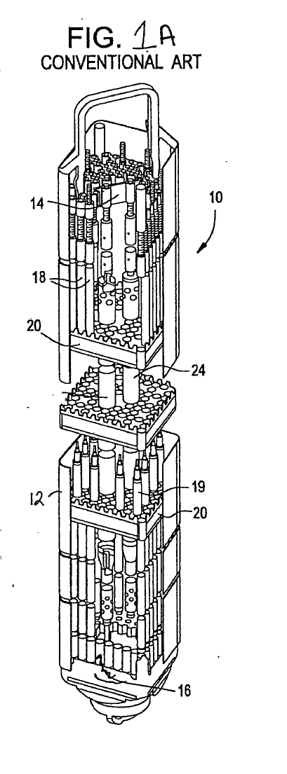

### DETAILED DESCRIPTION OF EXAMPLE EMBODIMENTS

Various example embodiments will now be described more fully with reference to the accompanying drawings in which some example embodiments are illustrated. In the drawings, the thicknesses of layers and regions may be exaggerated for clarity.

Detailed illustrative embodiments are disclosed herein. However, specific structural and functional details disclosed herein are merely representative for purposes of describing example embodiments. This invention may, however, be embodied in many alternate forms and should not be construed as limited to only example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the scope of example embodiments.

Spatially relative terms, e.g. “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g. those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, the example embodiments are not limited to example embodiments described.

Example embodiments will now be described more fully with reference to the accompanying drawings, in which exemplary embodiments of the invention are shown. The example embodiments may, however, be embodied in many different forms and should not be construed as being limited to the embodiments set forth herein. Rather, these embodiments are provided so that this disclosure will be thorough and complete, and will fully convey the scope of the invention to one of ordinary skill in the art. In the drawings, the sizes of constitutional elements may be exaggerated for convenience of illustration.

Example embodiments are directed to reducing the shadow-forming tendency of nuclear reactor components formed of, nickel alloys (e.g., INCONEL), iron alloys (e.g., stainless steels), etc., by using a thin coating to reduce the difference in electrochemical potential between the component and any adjacent and/or nearby zirconium alloy based components to thereby reduce the formation of shadow corrosion on the zirconium alloy. The nuclear reactor components may include, parts of a fuel assembly, for example, spacers, spacer springs, tie plates, control blades, etc. The terms adjacent and nearby are to be construed broadly as including, e.g., the at least two components being directly in contact with each other, to the at least the two components being within the same reactor.

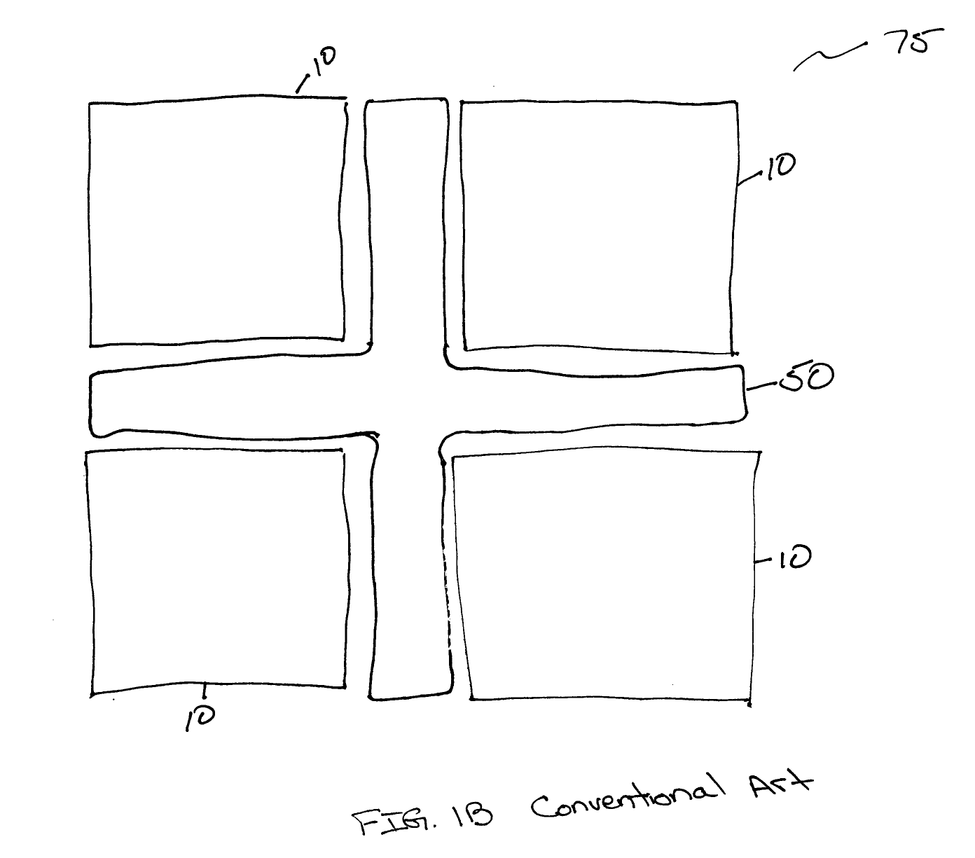

As shown in FIG. 2A, a nuclear reactor component, for example, a spacer 20 has a material layer 300 formed on a surface thereof. The material layer 300 is stable in various nuclear reactor environments, e.g., BWR reactors, and does not crack and/or spall during nuclear processing. Material layer 300 may be any material that when formed on nuclear component 20 reduces the difference between the electrochemical corrosion potential of the nuclear component 20 and at least one adjacent zirconium alloy component. Such materials for the material layer 300, may include, titanium, zirconium, hafnium, yttrium, scandium, alloys and oxides thereof, etc., (e.g., Zircaloy-2 with 0.25% iron (GNF-Ziron), High Fe—Ni Zircaloy, Zr—Sn—Fe—Cr alloy (VB)), and any other similar materials, which would be converted to an oxide by in-reactor corrosion. GNF-Ziron is further described in U.S. Pat. No. 4,810,461, which is hereby incorporated in its entirety by reference and VB is further described in U.S. Pat. No. 5,712,888, which is hereby incorporated in its entirety by reference. The various oxides are effective because the oxides achieve a similar electrochemical corrosion potential as the adjacent zirconium alloy component. The adjacent zirconium alloy component may include, e.g., Zircaloy-2, Zircaloy-4, Zr—Sn alloys, Zr—Sn—Fe—Cr—Ni alloys, Zr—Nb alloys, etc.

The material layer 300 may be deposited by various well known methods. For example, material layer 300 may be formed using chemical vapor deposition (CVD), plasma vapor deposition (PVD), plasma enhanced chemical vapor deposition (PECVD), plasma thermal spraying, high-velocity oxy-fuel (HVOF) thermal spraying, wire arcing, electroless deposition, and/or electroplating. In addition, the material layer 300 may be formed using ion implantation, including, for example, at least one ion source including zirconium, titanium, hafnium, and/or scandium.

According to example embodiments, the material layer 300 may be thin, e.g., generally about 25 microns or less. By using a thin material layer 300, coolant flow through and/or around the component 20 is not significantly affected by the presence of the material layer 300.

In other example embodiments, as shown in FIG. 2B a buffer layer 310 may be formed between the nuclear component 20 and the material layer 300. Buffer layer 310 may increase the adhesion between the material layer 300 and the component 20 and may be formed from tantalum, its oxides, and alloys. The buffer layer 310 may be formed using similar methods as discussed above with reference to material layer 300 and the combination of material layer 300 and buffer layer 310 may also be about 25 microns or less.

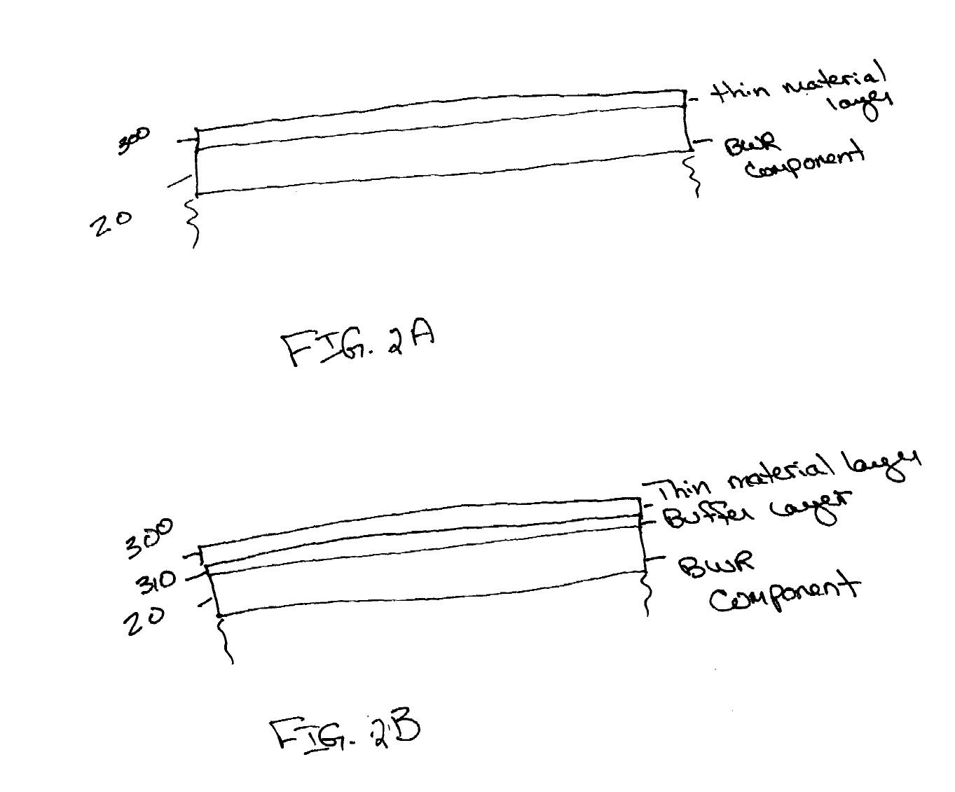

FIG. 3 shows a graph of the electrochemical corrosion potential (ECP) behavior of 304 SS, Zircaloy-2 and pure Zr as a function of oxygen concentration in 288° C. water. As is illustrated, pure Zr has the lowest potential, approximately −850 mV, while Zircaloy-2 is in the middle, ranging from approximately −600 to −200 mV, and 304 SS has the highest potential ranging from approximately −400 to 200 mV. Nickel-based alloys, such as INCONEL 600, INCONEL X750, etc., show similar ECP behavior as 304 SS in high temperature water.

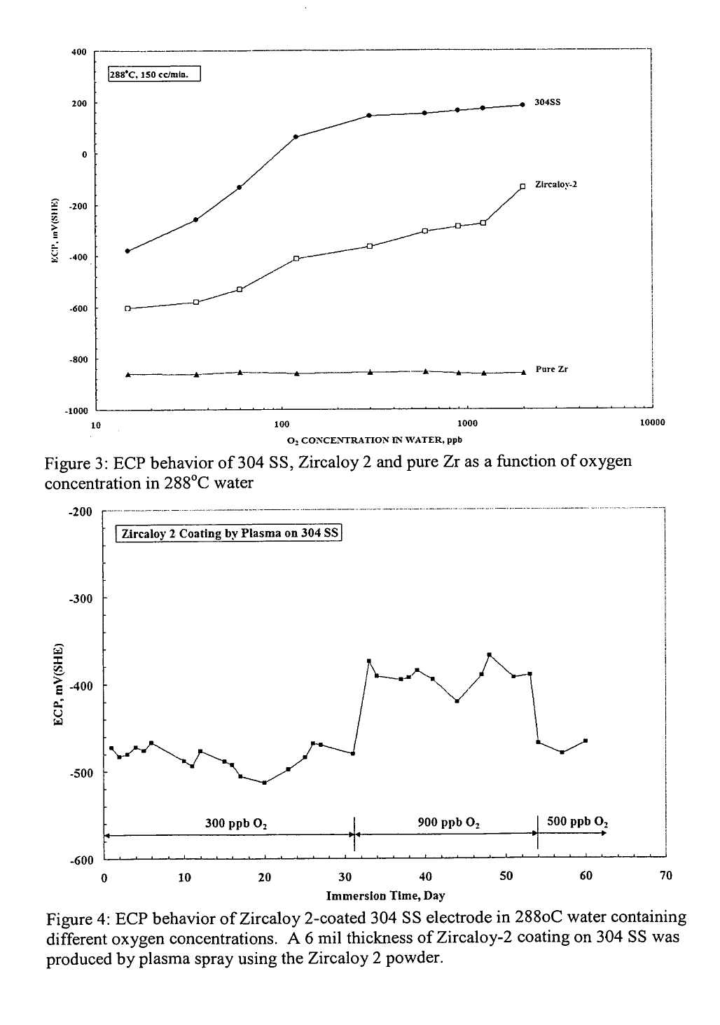

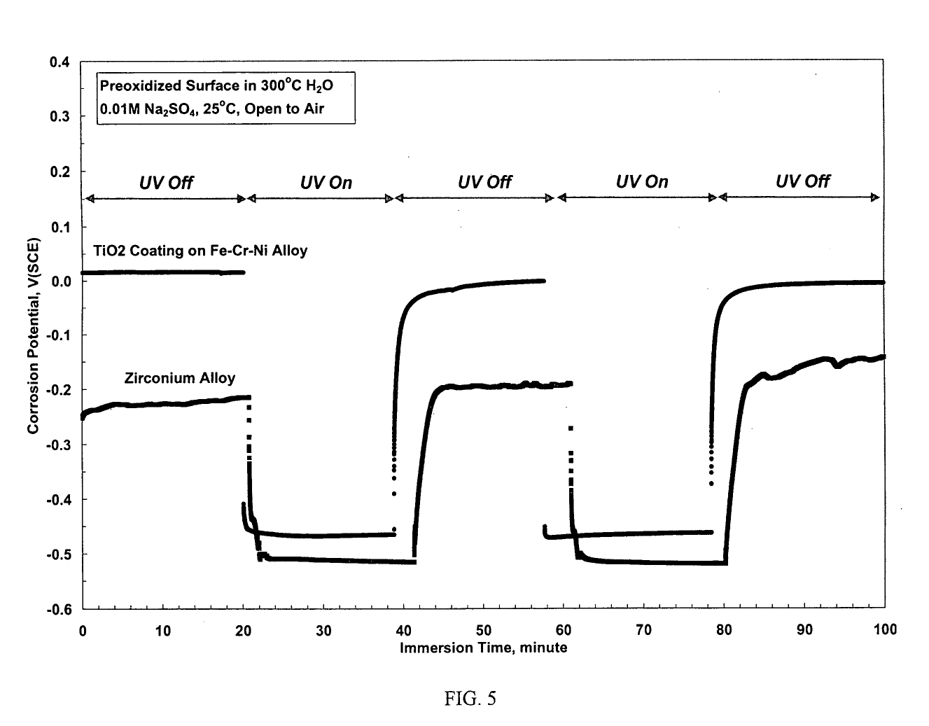

As shown in FIG. 4, the electrochemical corrosion potential of 304 SS may be reduced by forming a Zircaloy-2 layer on the surface thereof. The coated 304 SS shows a decrease in potential from approximately −400 to 200 mV (shown in FIG. 3) to approximately −470 to −380 mV (shown in FIG. 5) depending on the oxygen concentration. By coating the 304 SS component with a thin layer of Zircaloy-2, the ECP decreased and the difference between the coated 304 SS component and an adjacent Zircaloy-2 component would also decrease thereby reducing the corrosion of the Zircaloy-2 component (shown in FIG. 4). Thus, the coating of Zr-based alloys, e.g., Zircaloy 2, on Fe-based alloy (e.g., 304 SS) or Ni-based alloy (e.g., Alloy X750) restricts the oxygen oxidation reaction and decreases the ECP close to values of Zircaloy 2.

FIG. 5 further illustrates the decrease in the ECP difference between a non-zirconium alloy component coated with a thin material layer and a zirconium alloy component, by showing a comparison of the corrosion potential behavior. FIG. 5 illustrates the corrosion potential behavior of a TiO2 coated Fe—Cr—Ni alloy component (produced by CVD) and a zirconium alloy component with and without UV illumination in 0.01M Na2SO4 solution at 25° C. The UV illumination is used to simulate in reactor processing. For the experiment illustrated, both components were pre-oxidized in 300° C. water containing 500 ppb O2 before the UV illumination. As FIG. 5 shows, the electrically non-conducting oxide film prevents and/or greatly restricts mass transport of oxidants to the component's metal surface causing the ECP to shift to a low value even at high oxidants levels during UV illumination.

Although example embodiment fuel assembly components may be inserted into BWR-type fuel rods and fuel bundles in example embodiments, it is understood that other types of fuel and power plants may be usable with example embodiment retention devices. For example, PWR, CANDU, RBMK, ESBWR, etc. type reactors may include fuel rods that can accommodate example embodiment retention devices in order to irradiate irradiation targets therein.

Example embodiments thus being described, it will be appreciated by one skilled in the art that example embodiments may be varied through routine experimentation and without further inventive activity. For example, other fuel types, shapes, and configurations may be used in conjunction with example embodiment fuel bundles and tie plate attachments. Variations are not to be regarded as departure from the spirit and scope of the exemplary embodiments, and all such modifications as would be obvious to one skilled in the art are intended to be included within the scope of the following claims.

What is claimed is:

1. A nuclear reactor, comprising:
a first component being formed of at least one material selected from nickel based alloys and iron based alloys;
a second component adjacent to the first component, the second component being formed of a zirconium alloy; and
a material layer formed on at least one surface of the first component, the material layer being formed of a different material than the first component such that a difference in electrochemical corrosion potential between the first component and the second component is reduced.

2. The nuclear reactor of claim 1, wherein the first component is one of, a control blade, a spacer, a spring, an upper tie plate, and a lower tie plate.

3. The nuclear reactor of claim 1, wherein the material layer is formed on the first component such that corrosion resistance of the second component is enhanced.

4. The nuclear reactor of claim 1, wherein the material layer is selected from one of the following materials, titanium, zirconium, hafnium, yttrium, scandium, alloys thereof, and oxides thereof.

5. The nuclear reactor of claim 4, wherein the zirconium alloys include, Zircaloy-2, Zircaloy-4, Zr—Sn alloys, Zr—Sn—Fe—Cr—Ni alloys, Zr—Sn—Fe—Cr alloys, and Zr—Nb alloys.

6. The nuclear reactor of claim 1, further comprising:
a buffer layer formed between the at least one surface of the first component and the material layer.

7. The nuclear reactor of claim 6, wherein the buffer layer is formed such that the adherence of the material layer to the at least one surface of the first component is increased.

8. The nuclear reactor of claim 6, wherein the buffer layer includes, tantalum, tantalum oxide, and tantalum alloys.

9. The nuclear reactor of claim 1, wherein the material layer has a thickness equal to or less than 25 μm.

10. The nuclear reactor of claim 6, wherein the combination of the buffer layer and the thin material layer is equal to or less than 25 μm.

11. A method of enhancing zirconium corrosion resistance in a nuclear reactor fuel assembly, comprising:
forming a material layer on at least one surface of a first component adjacent to a second component, such that a difference in electrochemical potential between the first component and the second component is reduced.

12. The method of claim 11, wherein the material layer is selected from one of the following materials, titanium, zirconium, hafnium, yttrium, scandium, alloys thereof, and oxides thereof.

13. The method of claim 12, wherein the zirconium alloys include, Zircaloy-2, Zircaloy-4, Zr—Sn alloys, Zr—Sn—Fe—Cr—Ni alloys, Zr—Sn—Fe—Cr alloys, and Zr—Nb alloys.

14. The method of claim 11, wherein the first component is formed of at least one material selected from nickel based alloys and iron based alloys.

15. The method of claim 11, wherein the first component is one of, a control blade, a spacer, a spring, an upper tie plate, and a lower tie plate.

16. The method of claim 11, further comprising:
forming a buffer layer between the at least one surface of the first component and the material layer.

17. The method of claim 16, wherein the buffer layer is formed such that the adherence of the material layer to the at least one surface of the first component is increased.

18. The method of claim 16, wherein the buffer layer includes, tantalum, tantalum oxide, and tantalum alloys.

19. The method of claim 11, wherein the material layer has a thickness equal to or less than 25 μm.

20. The method of claim 16, wherein the combination of the buffer layer and the material layer has a thickness equal to or less than 25 μm.

21. The method of claim 11, wherein the coating step includes depositing the material layer by at least one of the following methods, chemical vapor deposition (CVD), plasma vapor deposition (PVD), plasma enhanced chemical vapor deposition (PECVD), plasma thermal spray, high-velocity oxy-fuel (HVOF) thermal spray, wire arc, electroless deposition, and electroplating.

22. The method of claim 11, wherein the coating step includes implanting the at least one surface of the first component by ion implantation.

23. The method of claim 22, wherein the implanting step includes implanting the at least one surface of the first component using at least one ion source including, Zr, Ti, Hf, and Sc.
